(19) United States
(12) Patent Application Publication
(10) Pub. No.: US 2007/0030121 A1
(43) Pub. Date: Feb. 8, 2007

(54) Remote control for a car's security or keyless entry system that also includes a voice recorder for storing and playing back short audio messages and a method for its use

(76) Inventor: Paul Soliz, Las Vegas, NV (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/199,677

(22) Filed: Aug. 8, 2005

(51) Int. Cl. B60R 25/00

(52) U.S. Cl. 340/5.72; 340/5.64; 340/426.36; 340/309.7; 340/825.25; 340/825.49

(57) ABSTRACT

A device combines a remote control for a car's keyless entry or security system with a compact voice recorder, capable of recording a short voice message and replaying this message at a later time. The device can be compact enough to be used as a keychain or easily carried in a pocket or purse. Also described is a method for finding a car by using the device to record a note describing the car's location and playing back this note later to refresh the user's recollection of where the car was parked.

### FIELD OF THE INVENTION

The present general inventive concept relates to electronic accessories for automobiles and more particularly, the present general inventive concept relates to a remote control for a car's security or keyless entry system that includes an integrated voice recorder capable of storing and playing back short audio messages and a method for its use.

### DESCRIPTION OF THE RELATED ART

Keyless entry systems and security systems are common accessories available on newer vehicles. Keyless entry systems allow a user to lock and unlock a car's doors by pressing buttons rather than using a key. These keyless entry systems are embodied in U.S. Pat. Nos. 4,755,823 and 5,134,392 and others. Keyless entry systems may also be combined with a car's security system or the keyless entry and security systems may be used separately. These systems generally include a remote control device, which is typically small enough to be attached to a standard keychain. These remote controls may have various functions including: locking and unlocking the car's doors, opening the trunk, activating and deactivating the car's security system, and activating a panic alarm to scare away attackers. Many aftermarket car security systems also include similar small remote controls to activate or deactivate a car's security system.

Voice recording devices, have been in existence for many years and are available in many configurations including tape recorders and a variety of digital recording devices. In recent years, battery-powered, stand-alone, digital recording devices have become widely available. These digital recording devices are embodied in U.S. Pat. Nos. 6,904,406 and 4,309,571 and others.

### SUMMARY OF THE INVENTION

It is an aspect of the present general inventive concept to provide a dual- purpose remote control for an automobile's keyless entry system or alarm system that also allows the user to record and play back short voice notes.

The above aspects can be obtained by a dual-purpose device that includes: (a) a remote control for an automobile's keyless entry system or security system and (b) a small audio recording device that can also play back the short audio messages it has recorded.

the above aspects can also be obtained by a method for using the device that includes: (1) parking a car in a parking spot, (2) using the device to lock the car doors, activate the security system, or both, (3) locating signage or landmarks that can be used to relocate the car when returning to it, (4) making a short voice recording of the signage or landmarks located, (5) leaving the car to perform tasks or activities, (6) returning to the general area where the car was parked, (7) play back the short voice recording to refresh the driver's recollection of the signage or landmark near the parking spot, (8) proceed to the recollected signage or landmarks and visually locate the car, and (9) use the device to unlock the car doors, deactivate the security system, or both.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing illustrating an isometric view of a dual-purpose remote control for a car's keyless entry/security system having an integrated voice record-and-play feature, according to an embodiment;

FIG. 2 is a drawing illustrating a schematic diagram of a dual-purpose remote control for a car's keyless entry/security system having an integrated voice record-and-play feature, according to an embodiment;

FIG. 3 is a flowchart describing a method of using a dual-purpose remote control for a car's keyless entry/security system having an integrated voice record-and-play feature to both find a parked car and operate the locks and/or the alarm system of a car, according to an embodiment;

FIG. 4 is a drawing depicting a car, parked in a parking lot, near a sign marking a particular subsection of the parking lot, according to an embodiment;

FIG. 5 is a drawing depicting a person using a dual-purpose remote control for a car's keyless entry/security system having an integrated voice record-and-play feature to record a voice memo noting where he or she has parked, according to an embodiment; and

FIG. 6 is a drawing depicting a person using a dual-purpose remote control for a car's keyless entry/security system having an integrated voice record-and-play feature to play back a voice memo noting where he or she has parked to refresh his or her recollection, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

Recording devices have been used for decades for the purpose of making oral notes. However, until recently, these devices were too large to be carried comfortably in a person's pocket. These devices have tended to be large, in part, because they were designed to record and play back recordings of an hour or more in length. Devices designed to store only a few seconds of oral notes could be made much smaller because the memory components and the battery requirements of such a device would be greatly reduced. Additionally, by combining the recording device with a car's keyless entry/security system remote control, the present invention can be further reduced by the shared use of an exterior covering and battery. These factors, in addition to improved and more compact technology, can allow the present invention to be made compact enough to be keychain-sized or of similar dimensions.

The present invention, in conjunction with a method of use, can be used to overcome a problem confronted by thousands of drivers each day: forgetting where they parked their car. Most large shopping centers and sporting facilities are surrounded by expansive parking lots or large parking garages where it is easy to lose a parked car. To assist visitors at these shopping and sporting facilities to locate their vehicles, subsections of these parking lots and parking garages are commonly marked with numbers, letters, or names to help visitors remember where they have parked. However, it can be difficult to remember this information after several hours of shopping, attending a sporting event, or other activities.

The present invention solves this problem by providing a method, which allows the user to use the device described above to record a short audio memo noting the section, or other geographical marker, near where he or she has parked his or her car. Upon leaving a mall, sporting event, or other venue the user can play back the audio memo to refresh his or her memory as to where their car was parked.

Another aspect of this method is its ability to improve safety. Parking lots and parking garages are notoriously dangerous places because they put many cars and pedestrians in close proximity to one another and force drivers to perform difficult maneuvers such as backing out of parking spaces while watching for both pedestrians and other drivers. Additionally, poorly lit parking lots and parking garages have been known to be prime locations for muggers and other criminals to attack their victims. Drivers that cannot find their cars may spend much more time wandering around these dangerous parking lots and garages in search of their cars. The time saving aspect of the present invention and the method for its use improves safety by reducing the time spent by a driver walking around in such a dangerous environment.

The present general inventive concept relates to a remote control device for a car's security system, keyless entry system, or a combination of the two.

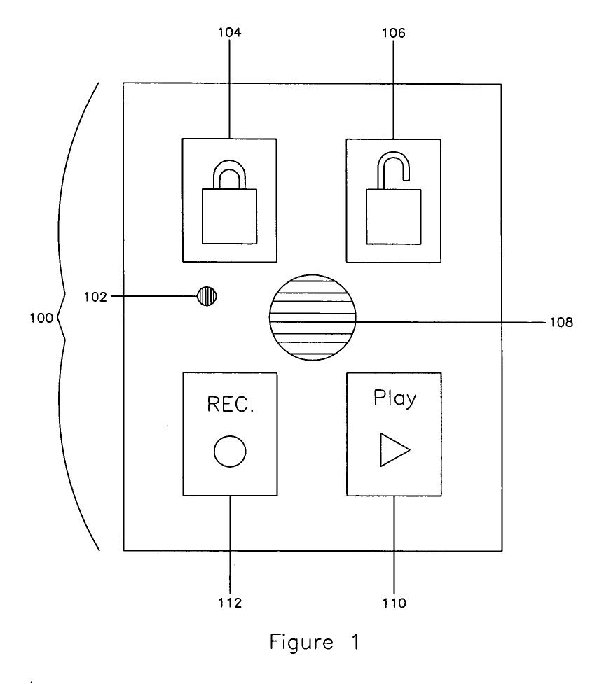

FIG. 1 is a drawing illustrating an isometric view of a dual-purpose remote control for a car's keyless entry/security system having an integrated voice record-and-play feature, according to an embodiment.

A dual-purpose remote control 100 for a car's keyless entry/security system (not pictured) having an integrated voice record-and-play feature can contain circuitry that allows it to wirelessly communicate with a car's keyless entry/security system. A keyless entry/security system can comprise a keyless entry system, a security system, or both a combined keyless entry and security system. The signals communicated between the keyless entry/car security remote control 100 and the keyless entry/security system can be initiated by pressing buttons on the remote control 100.

A ‘lock’ button 104 can be pressed to lock the car's doors, activate the car's security system, or both. An ‘unlock’ button 106 can be pressed to unlock the car's doors, deactivate the car's security system, or both. The remote can also contain a ‘panic’ button (not pictured) which allows the user to trigger an alarm using the remote control, a ‘trunk-open’ button, (not pictured) which allows the user to open the car's trunk lid using the remote control, and any number of additional buttons not described here.

In addition to the car alarm and keyless entry system, the remote control 100 can also contain the circuitry of an integrated voice record-and-play feature (not pictured). The remote control can also have a ‘record’ button 112 that can initiate the record function of the integrated voice record-and-play feature of the invention. The remote control can have a ‘play’ button 110 that can initiate a playback function of the integrated voice record-and-play feature of the invention.

When the record function is actuated by pressing the ‘record’ button 112, audio input is converted to an electrical signal using a microphone 102. The electrical signal can then be processed and stored using the circuitry of the integrated voice record-and-play feature.

The playback function is actuated by pressing the ‘play’ button 110. When the playback function is actuated, the stored signal is converted by the circuitry of the integrated voice record-and-play feature back into an electrical signal that can be converted into sound using a speaker 108.

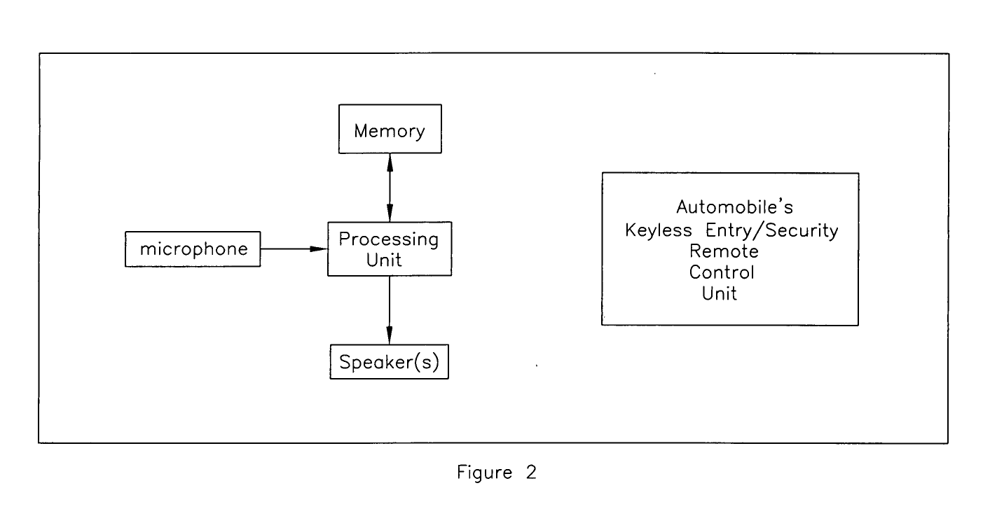

FIG. 2 is a drawing illustrating a schematic diagram of a dual-purpose remote control for a car's keyless entry/security system having an integrated voice record-and-play feature, according to an embodiment.

The remote control can contain circuitry for a car's keyless entry/security system 208, which can lock and unlock the car's doors and activate and deactivate the car's security system as well as other optional features. The remote control can also contain the circuitry and components required for a digital voice recorder and player.

The components of the digital voice recorder and player are a microphone 202 that can convert sounds to electrical signals, a processing unit 200 that can convert the electrical signals to digital data and vice versa, a memory component 204 that can store the digital data, and a speaker 206 that can convert electrical signals to audio.

When recording a voice memo, the microphone can convert the voice memo to electrical signals which can pass over a wire to a processing unit. The processing unit can then convert the electrical signals to digital data that can be stored in the memory component until needed.

When playing back the voice memo, the digital data stored in the memory component can be sent to the processing unit where it can be converted back into an electrical signal which can be passed over a wire to a speaker. The speaker can then convert the electrical signals to audio allowing the user to hear the voice memo they had recorded earlier.

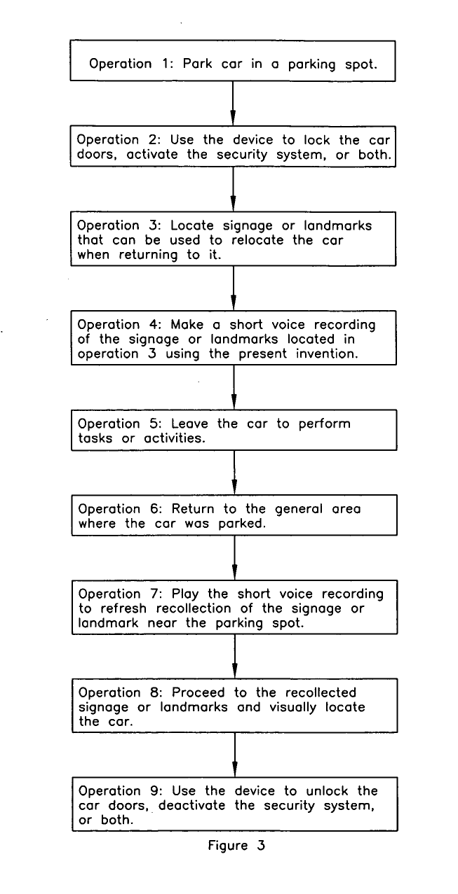

FIG. 3 is a flowchart describing a method of using a dual-purpose remote control for a car's keyless entry/security system having an integrated voice record-and-play feature to both find a parked car and operate the locks and/or the security system of a car, according to an embodiment.

The method described includes the following operations in order from beginning to end: (1) park a car in a parking spot, (2) use the device to lock the car doors, activate the security system, or both, (3) locate signage or landmarks that can be used to relocate the car when returning to it, (4) make a short voice recording of the signage or landmarks located, (5) leave the car to perform tasks or activities, (6) return to the general area where the car was parked, (7) play back the short voice recording to refresh the driver's recollection of the signage or landmark near the parking spot, (8) proceed to the recollected signage or landmarks and visually locate the car, and (9) use the device to unlock the car doors, deactivate the security system, or both.

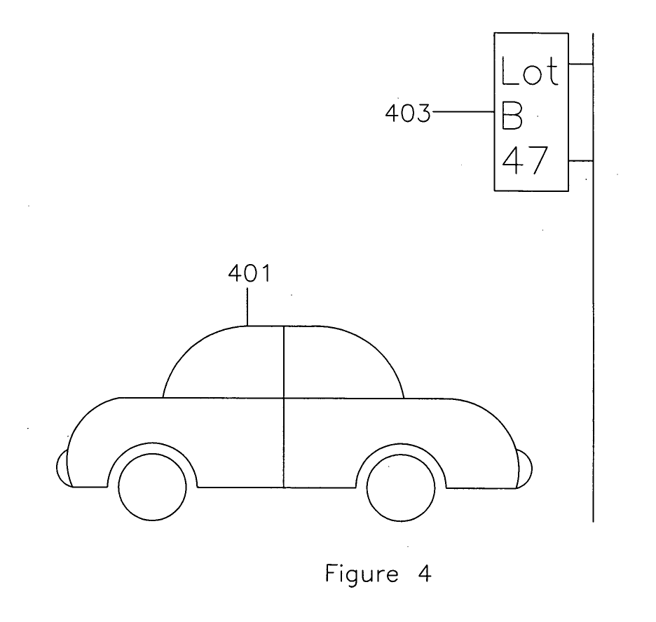

FIG. 4 is a drawing depicting a car 401, parked in a parking lot, near a sign 403 marking the particular area of the parking lot, according to an embodiment.

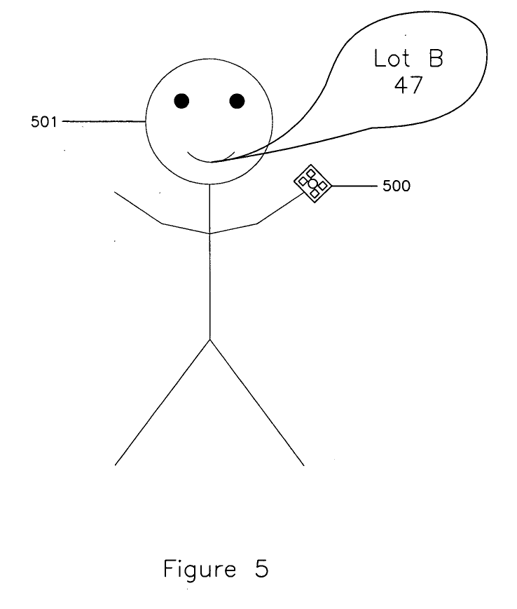

FIG. 5 is a drawing depicting a person 501 using a dual-purpose remote control 500 for a car's keyless entry/security system having an integrated voice record-and-play feature to record a voice memo noting where he or she has parked, according to an embodiment. This drawing depicts the execution of Operation 4 of the flowchart of the method described in FIG. 3.

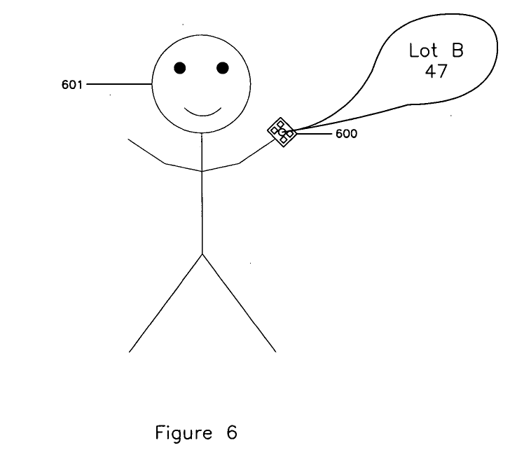

FIG. 6 is a drawing depicting a person using a dual-purpose remote control for a car's keyless entry/security system having an integrated voice record-and-play feature to play back a voice memo noting where he or she has parked to refresh his or her recollection, according to an embodiment. This drawing depicts the execution of Operation 7 of the flowchart of the method described in FIG. 3.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A portable dual-purpose automotive accessory, the accessory comprising:
a keyless entry remote control unit; and
a voice recording unit,
wherein both the keyless entry remote control unit and the voice recording unit are housed within the portable dual-purpose automotive accessory.

2. The dual-purpose automotive accessory recited in claim 1, wherein the voice recording unit is digital.

3. The dual-purpose automotive accessory recited in claim 1, wherein the device is key-chain sized.

4. The dual-purpose automotive accessory recited in claim 2, wherein the device is key-chain sized.

5. A keychain-sized dual-purpose automotive accessory, the accessory comprising:
a keyless entry remote control unit;
a digital voice recording unit,
wherein both the keyless entry remote control unit and the digital voice recording unit are housed within the portable dual-purpose automotive accessory.

6. A method of using a dual-purpose remote control of a car's keyless entry/security system having an integrated voice record-and-play feature to locate where a driver has parked his or her car comprising:
using the device to lock a car's doors and/or activate the car's security system;
locating signage or landmarks near the car;
recording a short audio message noting the signage or landmarks near where the car has been parked;
replaying the short audio message, when necessary, to refresh the user's memory as to where he or she had parked; and
proceeding to the signage or landmarks recollected, and visually locating the car.

7. A method as in claim 6 wherein the device comprises:
a portable dual-purpose automotive accessory, the accessory further comprising:
a keyless entry remote control unit; and
a voice recording unit,
wherein both the keyless entry remote control unit and the voice recording unit are housed within the portable dual-purpose automotive accessory.

8. A method as in claim 6 wherein the device comprises:
a portable dual-purpose automotive accessory, the accessory further comprising:
a keyless entry remote control unit; and
a digital voice recording unit,
wherein both the keyless entry remote control unit and the digital voice recording unit are housed within the portable dual-purpose automotive accessory.

9. A method as in claim 6 wherein the device comprises:
a keychain-sized dual-purpose automotive accessory, the accessory further comprising:
a keyless entry remote control unit; and
a voice recording unit,
wherein both the keyless entry remote control unit and the voice recording unit are housed within the portable dual-purpose automotive accessory.

10. A method as in claim 6 wherein the device comprises:
a keychain-sized dual-purpose automotive accessory, the accessory further comprising:
a keyless entry remote control unit; and
a digital voice recording unit,
wherein both the keyless entry remote control unit and the digital voice recording unit are housed within the portable dual-purpose automotive accessory.
